(19) United States
(12) Patent Application Publication
(10) Pub. No.: US 2026/0092646 A1
(43) Pub. Date: Apr. 2, 2026

(54) CONTROL OF A FREE-WHEELING VALVE

(71) Applicant: POCLAIN HYDRAULICS INDUSTRIE, VERBERIE (FR)

(72) Inventors: Matej ERZNOZNIK, VERBERIE (FR); Mufid Bešic, VERBERIE (FR); Jernej Bradeško, VERBERIE (FR)

(21) Appl. No.: 19/113,187

(22) PCT Filed: Sep. 21, 2023
(86) PCT No.: PCT/FR2023/051445

§ 371 Date: Mar. 19, 2025

(30) Foreign Application Priority Data
Sep. 22, 2022 (FR) 2209640

(51) Int. Cl. F16H 61/4035; B60K 7/00; F16H 61/4139

(52) U.S. Cl. CPC F16H 61/4035; B60K 7/0015; F16H 61/4139

(57) ABSTRACT

The present invention relates to an assembly for a traction assistance hydraulic circuit of a vehicle, the assembly comprising: a free-wheeling valve (1); a hydraulic pilot valve (2) connected to the free-wheeling valve (1) and configured to drive the free-wheeling valve (1); and a directional solenoid valve (3) connected to the hydraulic pilot valve (2) and configured to control the hydraulic pilot valve (2).

### TECHNICAL FIELD

The present disclosure relates to the field of hydraulic assistance for vehicle traction. More specifically, it concerns the control of a free-wheeling valve within a hydraulic circuit for assisting vehicle traction.

### PRIOR ART

In a hydraulic circuit for assisting the traction of a vehicle, at least one hydraulic motor may be engaged with at least one wheel when a surplus of motor force is needed to drive it, for example when the vehicle is travelling over a bumpy or slippery ground surface. Once the vehicle is moving at a high enough speed or the traffic conditions are so that the motor force is adequate, the motor can be disengaged from the wheel.

For this purpose, the hydraulic circuit is generally equipped with a free-wheeling valve, the different positions of which allow the engagement and disengagement of the motor. The different positions are commonly commanded by a control valve. The control valve is usually a directional electrohydraulic valve with direct control.

Certain motors are suitable for being disengaged by the retraction of pistons of the motor. To do this, intake and/or discharge orifices of the motor must be put in communication with a reservoir of the hydraulic circuit, or with a booster circuit, by way of the free-wheeling valve and the control valve. The engagement and disengagement of the engine must be able to be implemented quickly enough, especially when the vehicle is driving and the engine continues to run during the engagement or disengagement. This speed of execution is specifically useful to minimize mechanical impacts, torque jolts, engine wear, pressure spikes and noise. Because of this the flow rates that circulate through the control valve are very high, which requires significant energy to switch it.

Such control valves are therefore very heavy and very bulky, particularly because they are equipped with a large solenoid to command their operation. Furthermore, they have a high cost and consume a large amount of energy. For example, such a control valve can typically operate with an amperage greater than 2.5 A and an electrical power greater than 30 W.

### GENERAL DISCLOSURE

One aim of the present disclosure is to allow the controlling of a free-wheeling valve in a way that is less expensive and less energy-hungry.

To this end provision is made, according to an aspect of the present disclosure, for an assembly for a hydraulic circuit for assisting the traction of a vehicle, the assembly comprising a free-wheeling valve; a hydraulic control valve connected to the free-wheeling valve and configured to control the free-wheeling valve; and a directional electric valve connected to the hydraulic control valve and configured to control the hydraulic control valve.

The hydraulic control valve may comprise a first inlet port provided to be connected to a reservoir of the circuit; a second inlet port provided to be connected to a booster line of the circuit; and an outlet port connected to a control chamber and to a second inlet port of the free-wheeling valve.

The hydraulic control valve may further comprise a slide and a body, the slide being movable within the body between a first position in which the slide allows the circulation of fluid between the first inlet port and the outlet port of the hydraulic control valve, and prohibits the circulation of fluid between the second inlet port and the outlet port of the hydraulic control valve; and a second position in which the slide allows the circulation of fluid between the second inlet port and the outlet port of the hydraulic control valve, and prohibits the circulation of fluid between the first inlet port and the outlet port of the hydraulic control valve.

The hydraulic control valve can further comprise a control chamber connected to the directional electric valve and connected to the slide of the hydraulic control valve so that a pressure within the control chamber exerts a first force on the slide of the hydraulic control valve; and a return element connected to the slide and to the body of the hydraulic control valve, so as to exert a second force on the slide of the hydraulic control valve; wherein a movement of the slide of the hydraulic control valve between the first position and the second position of the hydraulic control valve is controlled by a difference between the first force and the second force on the slide of the hydraulic control valve.

The directional electric valve may comprise a first inlet port provided to be connected to a reservoir of the circuit; a second inlet port provided to be connected to a booster line of the circuit; and an outlet port connected to a control chamber of the hydraulic control valve. The directional electric valve may further comprise a slide and a body, the slide being movable within the body between a first position in which the slide allows the circulation of fluid between the first inlet port and the outlet port of the directional electric valve, and prohibits the circulation of fluid between the second inlet port and the outlet port of the directional electric valve; and a second position in which the slide allows the circulation of fluid between the second inlet port and the outlet port of the directional electric valve, and prohibits the circulation of fluid between the first inlet port and the outlet port of the directional electric valve.

The directional electric valve may further comprise a solenoid configured to exert a first force on the slide of the directional electric valve; and a return element connected to the slide and to the body of the directional electric valve, so as to exert a second force on the second slide of the directional electric valve; wherein a movement of the slide of the directional electric valve between the first position and the second position of the directional electric valve is controlled by a difference between the first force and the second force on the slide of the directional electric valve.

The free-wheeling valve may comprise a first inlet port provided to be connected to a first orifice of a hydraulic pump of the circuit; a second inlet port provided to be connected alternatively to a reservoir of the circuit or to a booster line of the circuit, by way of the hydraulic control valve; a third inlet port provided to be connected to a second orifice of the pump; a first outlet port provided to be connected to a first orifice of a hydraulic motor of the circuit; and a second outlet port provided to be connected to second orifice of the motor.

The free-wheeling valve may further comprise a slide and a body, the slide being movable within the body between a first position in which the slide allows the circulation of fluid between the second inlet port and each of the first outlet port and of the second outlet port of the free-wheeling valve, and prohibits the circulation of fluid between each of the first inlet port and of the third inlet port, and each of the first outlet port and of the second outlet port of the free-wheeling valve; and a second position in which the slide allows the circulation of fluid between the first inlet port and the first outlet port, and between the third inlet port and the second outlet port of the free-wheeling valve, and prohibits the circulation of fluid between the first inlet port and the second outlet port, between the second inlet port and each of the first outlet port and of the second outlet port, and between the third inlet port and the first outlet port of the free-wheeling valve.

The free-wheeling valve may further comprise a control chamber connected to the hydraulic control valve and connected to the slide of the free-wheeling valve so that a pressure within the control chamber exerts a first force on the slide of the free-wheeling valve; and a return element connected to the slide and to the third body of the free-wheeling valve, so as to exert a second force on the slide of the free-wheeling valve;
wherein a movement of the slide of the free-wheeling valve between the first position and the second position of the free-wheeling valve is controlled by a difference between the first force and the second force on the slide of the free-wheeling valve.

The free-wheeling valve may comprise a first inlet port provided to be connected to a first orifice of a hydraulic pump of the circuit; a second inlet port provided to be connected alternatively to a reservoir of the circuit or to a booster line of the circuit, by way of the hydraulic control valve; a third inlet port provided to be connected to a second orifice of the pump; a first outlet port provided to be connected to a first orifice of a hydraulic motor of the circuit; a second outlet port provided to be connected to second orifice of the motor; a slide and a body, the slide being movable within the body between a first position in which the slide allows the circulation of fluid between the second inlet port and each of the first outlet port and of the second outlet port of the free-wheeling valve, and prohibits the circulation of fluid between each of the first inlet port and of the third inlet port, and each of the first outlet port and of the second outlet port of the free-wheeling valve; and a second position in which the slide allows the circulation of fluid between the first inlet port and the first outlet port, and between the third inlet port and the second outlet port of the free-wheeling valve, and prohibits the circulation of fluid between the first inlet port and the second outlet port, between the second inlet port and each of the first outlet port and of the second outlet port, and between the third inlet port and the first outlet port of the free-wheeling valve; a control chamber connected to the hydraulic control valve and connected to the slide of the free-wheeling valve so that a pressure within the control chamber exerts a first force on the slide of the free-wheeling valve; and a return element connected to the slide and to the third body of the free-wheeling valve, so as to exert a second force on the slide of the free-wheeling valve; wherein a movement of the slide of the free-wheeling valve between the first position and the second position of the free-wheeling valve is controlled by a difference between the first force and the second force on the slide of the free-wheeling valve. The hydraulic control valve may comprise a first inlet port provided to be connected to the reservoir of the circuit; a second inlet port provided to be connected to the booster line of the circuit; an outlet port connected to the control chamber and to the second inlet port of the free-wheeling valve; and a slide and a body, the slide being movable within the body between a first position in which the slide allows the circulation of fluid between the first inlet port and the outlet port of the hydraulic control valve, and prohibits the circulation of fluid between the second inlet port and the outlet port of the hydraulic control valve; and a second position in which the slide allows the circulation of fluid between the second inlet port and the outlet port of the hydraulic control valve, and prohibits the circulation of fluid between the first inlet port and the outlet port of the hydraulic control valve; and wherein, in the first position of the slide of the free-wheeling valve and in the second position of the slide of the free-wheeling valve, the free-wheeling valve and the hydraulic control valve are configured to connect the booster line to the control chamber of the free-wheeling valve and to the motor.

The free-wheeling valve may comprise a first inlet port provided to be connected to a first orifice of a hydraulic pump of the circuit; a second inlet port provided to be connected alternatively to a reservoir of the circuit or to a booster line of the circuit, by way of the hydraulic control valve; a third inlet port provided to be connected to a second orifice of the pump; a first outlet port provided to be connected to a first orifice of a hydraulic motor of the circuit; a second outlet port provided to be connected to second orifice of the motor; a slide and a body, the slide being movable within the body between a first position in which the slide allows the circulation of fluid between the second inlet port and each of the first outlet port and of the second outlet port of the free-wheeling valve, and prohibits the circulation of fluid between each of the first inlet port and of the third inlet port, and each of the first outlet port and of the second outlet port of the free-wheeling valve; and a second position in which the slide allows the circulation of fluid between the first inlet port and the first outlet port, and between the third inlet port and the second outlet port of the free-wheeling valve, and prohibits the circulation of fluid between the first inlet port and the second outlet port, between the second inlet port and each of the first outlet port and of the second outlet port, and between the third inlet port and the first outlet port of the free-wheeling valve; a control chamber connected to the hydraulic control valve and connected to the slide of the free-wheeling valve so that a pressure within the control chamber exerts a first force on the slide of the free-wheeling valve; and a return element connected to the slide and to the third body of the free-wheeling valve, so as to exert a second force on the slide of the free-wheeling valve; wherein a movement of the slide of the free-wheeling valve between the first position and the second position of the free-wheeling valve is controlled by a difference between the first force and the second force on the slide of the free-wheeling valve. The hydraulic control valve may comprise a first inlet port provided to be connected to the reservoir of the circuit; a second inlet port provided to be connected to the booster line of the circuit; and an outlet port connected to the control chamber and to the second inlet port of the free-wheeling valve; and wherein the assembly further comprises a line connecting the outlet port of the control valve to the control chamber of the free-wheeling valve, the line comprising a nozzle provided to adjust a flow rate coming from the booster line.

The hydraulic control valve may further comprise a slide and a body, the slide being movable within the body between a first position in which the slide allows the circulation of fluid between the first inlet port and the outlet port of the hydraulic control valve, and prohibits the circulation of fluid between the second inlet port and the outlet port of the hydraulic control valve; and a second position in which the slide allows the circulation of fluid between the second inlet port and the outlet port of the hydraulic control valve, and prohibits the circulation of fluid between the first inlet port and the outlet port of the hydraulic control valve.

The hydraulic control valve may further comprise a control chamber connected to the directional electric valve and connected to the slide of the hydraulic control valve so that a pressure within the control chamber exerts a first force on the slide of the hydraulic control valve; and a return element connected to the slide and to the body of the hydraulic control valve, so as to exert a second force on the slide of the hydraulic control valve; wherein a movement of the slide of the hydraulic control valve between the first position and the second position of the hydraulic control valve is controlled by a difference between the first force and the second force on the slide of the hydraulic control valve.

The directional electric valve may comprise a first inlet port provided to be connected to a reservoir of the circuit; a second inlet port provided to be connected to a booster line of the circuit; and an outlet port connected to a control chamber of the hydraulic control valve. The directional electric valve may further comprise a slide and a body, the slide being movable within the body between a first position in which the slide allows the circulation of fluid between the first inlet port and the outlet port of the directional electric valve, and prohibits the circulation of fluid between the second inlet port and the outlet port of the directional electric valve; and a second position in which the slide allows the circulation of fluid between the second inlet port and the outlet port of the directional electric valve, and prohibits the circulation of fluid between the first inlet port and the outlet port of the directional electric valve.

The directional electric valve may further comprise a solenoid configured to exert a first force on the slide of the directional electric valve; and a return element connected to the slide and to the body of the directional electric valve, so as to exert a second force on the second slide of the directional electric valve; wherein a movement of the slide of the directional electric valve between the first position and the second position of the directional electric valve is controlled by a difference between the first force and the second force on the slide of the directional electric valve.

According to another aspect of the present disclosure, provision is made for a hydraulic circuit for assisting the traction of a vehicle, the circuit comprising a hydraulic motor provided to be coupled to a wheel of the vehicle; a hydraulic pump; and an assembly according to the disclosure; wherein the free-wheeling valve is configured to control the circulation of fluid between the pump and the motor.

The pump may comprise a first orifice and a second orifice and the hydraulic motor comprise a first orifice and a second orifice, the circuit further comprising a communicating circuit connecting the first orifice of the pump to the first orifice of the motor, and the second orifice of the pump to the second orifice of the motor, the communicating circuit comprising the free-wheeling valve; a reservoir; a booster pump comprising an intake orifice connected to the reservoir and a discharge orifice; and a booster line connected to the discharge orifice of the booster pump and to the communicating circuit; wherein the free-wheeling valve and the hydraulic control valve are configured to control the circulation of fluid between, on the one hand, the motor and, on the other hand, the pump, the booster line and/or the reservoir.

The hydraulic control valve can be configured to allow the circulation of fluid between the motor and the booster line and/or the reservoir at a flow rate between 50 and 100 liters per minute.

An engagement time and/or a disengagement time of the motor can be less than 1 second, preferably less than 0.5 seconds.

The directional electric valve may be configured to consume an electrical power of less than 20 W for the control of the hydraulic control valve.

According to another aspect of the present disclosure, provision is made for a vehicle comprising a primary axle provided to support at least one drive wheel of the vehicle; a secondary axle, separate from the primary axle; a wheel mounted on the secondary axle; and a circuit according to the disclosure, wherein the motor is coupled to the wheel.

According to another aspect of the present disclosure, provision is made for a method for controlling a vehicle, the vehicle comprising a primary axle provided to support at least one drive wheel of the vehicle, a secondary axle, separate from the primary axle, and a wheel mounted on the secondary axle, a method wherein:
a directional electric valve controls a hydraulic control valve; and
the hydraulic control valve controls a free-wheeling valve of a hydraulic motor of the vehicle coupled to the wheel;
wherein an enabling of the directional electric valve causes an enabling of the hydraulic control valve so as to enable the free-wheeling valve to set up a circulation of fluid first between the motor and a booster line of the vehicle then between a hydraulic pump of the vehicle and the motor; and
wherein a disabling of the directional electric valve causes a disabling of the hydraulic control valve so as to disable the free-wheeling valve to isolate the pump from the motor and connect the motor to a reservoir of the vehicle, by way of the hydraulic control valve.

### DESCRIPTION OF THE FIGURES

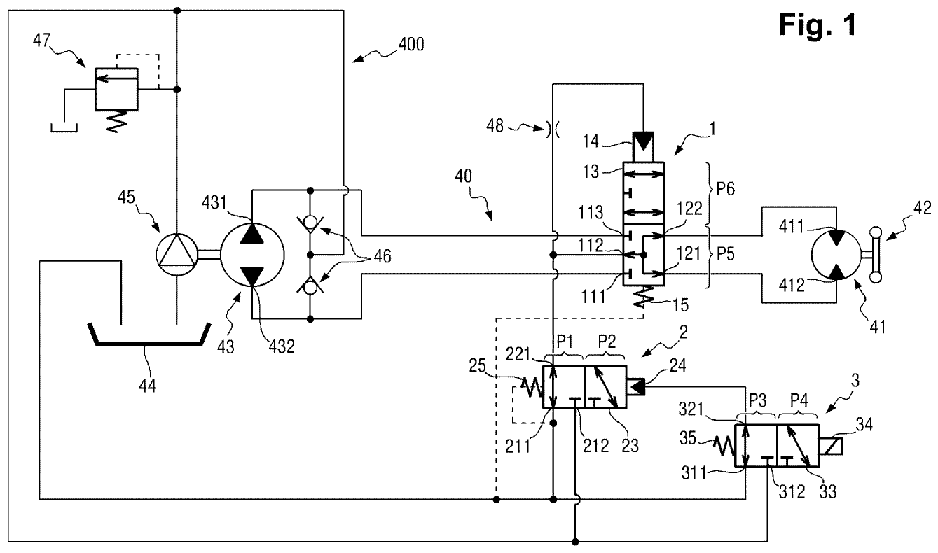

Other features, aims and advantages will become apparent from the following description, which is purely illustrative and non-limiting, and which must be read with reference to the appended FIG. 1 which schematically illustrates a hydraulic circuit for assisting the traction of a vehicle.

### DETAILED DESCRIPTION

A vehicle is generally equipped with at least one primary axle which supports at least one drive wheel of the vehicle. The drive wheel allows the vehicle to move, for example over land. Of course, the vehicle may comprise a plurality of primary axles and a plurality of drive wheels. Furthermore, the vehicle may comprise at least one secondary axle supporting at least one other wheel 42, a non-drive wheel, of the vehicle. Of course, the vehicle may comprise a plurality of secondary axles and a plurality of non-drive wheels 42. The wheels 42, although they are not drive wheels, can still play a part in the driving of the vehicle, for example by supporting a load of the vehicle, or providing the steering of the vehicle.

The vehicle can be agricultural engine or building site engine, for example a combine harvester or a grader. The vehicle can be an articulated vehicle, or a hitched vehicle, including a tractor part, and a drawn (or pushed) part, for example a trailer or a tool with drawn (or pushed) wheels.

FIG. 1 illustrates that the vehicle may further comprise a hydraulic circuit comprising a hydraulic pump 43. The hydraulic pump 43 can be driven, directly or not, by the primary motor of the vehicle, typically by way of a power takeoff connected to the primary motor, the power takeoff being able to be connected to the hydraulic pump 43 by way of a clutch. The primary motor of the vehicle may comprise a combustion engine and/or an electric motor. The hydraulic pump 43 comprises at least two orifices 431, 432 connected to a communicating circuit 40. The communicating circuit 40 comprises a high-pressure line, in the outflow direction of the hydraulic pump 43, and a low-pressure line, in the suction direction of the hydraulic pump 43. The direction of flow within the communicating circuit 40 can be modified. This modification can be implemented by reversing the direction of driving of the pump 43, using a flow direction reversing pump 43 and/or by making provision for a direction reversing valve within the communicating circuit 40.

In operation, the pressure that is set up within the communicating circuit 40 can be between 0 and 600 bar (i.e. 600·10⁵ Pa), typically between 0 and 500 bar (i.e. 500·10⁵ Pa). To supply the communicating circuit 40 with fluid and offset the many losses, a booster line 400 is connected to the communicating circuit 40. This booster line 400 is, for example, connected to the communicating circuit 40 by way of check valves 46 which can be seen on FIG. 1, typically with a check valve 46 arranged at the interface between the booster line 400 and the high-pressure line and a check valve 46 arranged at the interface between the booster line 400 and the low-pressure line. As described in more detail below, the pressure set up within the booster line 400 is also used as the hydraulic control pressure to operate the valves 1, 2 of the circuit. This booster pressure is between 5 and 20 bar (i.e. between 5.0·10⁵ and 20·10⁵ Pa), and typically has a value of 15 bar (i.e. 15·10⁵ Pa). The booster line 400 is itself supplied by way of a booster pump 45, which suctions a fluid through its intake orifice, from a hydraulic reservoir 44, and discharges the fluid, through its discharge orifice, through the booster line 400. The hydraulic reservoir 44, or pressureless reservoir 44, is at substantially atmospheric pressure, and defines the zero pressure reference of the circuit. The booster pump 45 can itself be driven by the primary motor of the vehicle by way of a power takeoff, for example the same drive as for the hydraulic pump 43, as can be seen on FIG. 1. The booster pump 45 can also be incorporated into the hydraulic pump 43. Alternatively, the booster pump 45 can be driven by an electric pump unit. The hydraulic reservoir 44 is in particular provided to collect the fluid coming from all the leaks of the circuit. FIG. 1 also illustrates a pressure-regulating valve 47 provided to regulate the pressure within the booster line 400, whatever the mode of operation of the booster pump 45, typically whatever the speed of the primary motor of the vehicle.

The circuit is used, in particular, for assisting the traction of the non-drive wheels 42. More precisely, the circuit can be used to provide, temporarily, a surplus torque to at least one of the non-drive wheels 42 of the vehicle. This surplus torque can in particular be necessary when the vehicle is driving over uneven or slippery ground. In such situations, skidding of the drive wheels can in fact occur, which, combined with a reduction in the torque provided by the primary axle, causes a reduction in the traction of the vehicle. In other words, the circuit makes It possible to temporarily increase the number of drive wheels of the vehicle. The circuit is moreover configured to disable its assistance when it is no longer necessary to provide a surplus of motor force to the vehicle wheels. The vehicle may include at least one, or even more, secondary axles assisted by the circuit, or even by several circuits similar to that illustrated in FIG. 1, typically one circuit per non-drive wheel 42 or one circuit per secondary axle. In any case, the vehicle can thus comprise a secondary axle which is assisted in a work mode of the vehicle, for example in a field or on a building site, and the assistance of which is disengaged in a road mode, for example when the vehicle is driving on a road surface.

The surplus torque is provided by way of a hydraulic motor 41 of the circuit, which is connected (or coupled) to the wheel 42, as can be seen on FIG. 1. The hydraulic motor 41 is able to provide a surplus torque to the wheel 42 owing to the hydraulic pump 43. The hydraulic pump 43 can be of similar structure and operation to the hydraulic motor 41, or not. The hydraulic motor 41 comprises at least two orifices 411, 412, the orifices 431, 432 of the hydraulic pump 43 being connected to the orifices 411, 412 of the hydraulic motor 41 by way of the communicating circuit 40. In this way, the hydraulic pump 43 can output a fluid through the hydraulic motor 41, by way of the communicating circuit 40, which allows the hydraulic motor 41 to develop a surplus torque to be transmitted to the wheel 42. FIG. 1 illustrates that the portion of the communicating circuit 40 connecting the hydraulic pump 43 to the hydraulic motor 41 is closed, i.e. all the fluid outputted by the hydraulic pump 43 which circulates through the hydraulic motor 41, returns to the hydraulic pump 43 before being sent out again to the hydraulic motor 41. Where applicable, the direction reversing valve in the communicating circuit 40 is arranged between the hydraulic pump 43 and the hydraulic motor 41, upstream or downstream of the free-wheeling valve 1, described in more detail below. The direction of flow of the fluid within this portion of the communicating circuit 40 and the determination of the high-pressure line and of the low-pressure line, depends on the direction of rotation of the wheel 42, i.e. on whether the vehicle is driving forward or reversing, and/or on the type of force transmitted to the wheel 42, i.e. in traction or in restraint. Typically, returning to FIG. 1, if the forward motion corresponds to a circulation of fluid in the clockwise direction in the communicating circuit 40, then, in traction, the high-pressure line will be connected to the inlet port 113 of the free-wheeling valve 1 and the low-pressure line will be connected to the inlet port 111 of the free-wheeling valve 1, and vice-versa in restraint, the inlet ports 111, 113 being described in more detail below. In reverse, assuming that the hydraulic pump 43 could have its direction of rotation reversed, the circulation of the fluid would occur in the anticlockwise direction in the communicating circuit 40, and high-pressure line and low-pressure line would be inverted, in traction and in restraint, compared to that described for forward motion.

The assistance of the traction of the wheel 42 must be able to be enabled or disabled according to the needs of the vehicle, typically at the command of the driver, for example according to travel conditions of the vehicle. Hence, provision can be made for the assistance to be enabled and/or disabled by the engagement and/or disengagement of the hydraulic motor 41, which moreover remains connected to the wheel 42. The engagement and/or disengagement can be done by extension and/or retraction of pistons into their respective housings, when the hydraulic motor 41 is equipped therewith, typically when the hydraulic motor 41 is a multilobe-cam, radial-piston engine.

In a multilobe-cam, radial-piston engine, the disengagement is typically implemented by isolating the hydraulic motor 41 from the hydraulic pump 43, and by connecting the orifices 411, 412 of the hydraulic motor 41 to the reservoir 44. In doing so, when the wheel 42 drives the hydraulic motor 41, the pistons are pushed back, by the cam and/or by the pressure set up in the casing of the hydraulic motor 41, in a retracted position, and the fluid located under the pistons is expelled toward the reservoir 44. Once in the retracted position, and as long as they remain isolated from the hydraulic pump 43 and connected to the reservoir 44, the pistons do not extend and the cam is then uncoupled from the pistons. The hydraulic motor 41 is then disengaged. Reciprocally, the engagement is typically implemented by extending the pistons so that they come into contact with the cam, and thus engage the hydraulic motor 41 with the wheel 42 so as to be able to transmit a torque and a rotational movement.

In the circuit illustrated on FIG. 1, the enabling and/or disabling of the assistance are implemented using a free-wheeling valve 1, which is arranged within the communicating circuit 40 so as to form the interface between hydraulic motor 41 and hydraulic pump 43, i.e. to control the circulation of fluid between the hydraulic pump 43 and the hydraulic motor 41, but also between hydraulic motor 41 and reservoir 44 and between hydraulic motor 41 and booster line 400. More precisely, it is the configuration of the free-wheeling valve 1 which controls the enabling and/or disabling of the assistance for the traction of the wheel 42, by putting the hydraulic motor 41 in communication with the booster line 400, then with the hydraulic pump 43 (enabling) and/or by putting the hydraulic motor 41 in communication with the reservoir 44 (disabling). Thus, the hydraulic reservoir 44 is not only provided to collect the fluid coming from all the leaks of the circuit, but also the fluid surplus coming from the communicating circuit 40 when the assistance is disabled.

The free-wheeling valve 1 comprises a plurality of inlet ports 111, 112, 113, in this case three inlet ports 111, 112, 113, and a plurality of outlet ports 121, 122, in this case two outlet ports 121, 122, as well as a slide 13 movable within a body (not shown) between different positions P5, P6, each position P5, P6 making it possible to set up and/or prohibit the circulation of fluid between inlet ports 111, 112, 113 and outlet ports 121, 122. Moreover, the free-wheeling valve 1 comprises a control chamber 14 and a return element 15. The control chamber 14 is provided to receive fluid until a pressure being set up within the control chamber 14 produces a force on the slide 13. In the same way, the return element 15 connects the slide 13 to the body so as to exert on the slide 13 a force antagonistic to the force exerted by the pressure being set up in the control chamber 14. Hence, a movement of the slide 13 within the body is controlled by the difference between these antagonistic forces of the pressure within the control chamber 14 and the return element 15. FIG. 1 moreover illustrates that any leak of fluid between the slide 13 and the body of the free-wheeling valve 1 is redirected toward the reservoir 44. Of course, all the other leaks of the circuit, for example internal leaks of the hydraulic pump 43 and of the hydraulic motor 41 and the leaks of the other components 3, 47 can also be drained to the reservoir 44.

In an idle position P5, or default position, in which the pressure within the control chamber 14 of the free-wheeling valve 1 is negligible compared to the force exerted by the return element 15 the free-wheeling valve 1, the slide 13 of the free-wheeling valve 1 allows the circulation of fluid between its two outlet ports 121, 122, each connected to one of the orifices 411, 412 of the hydraulic motor 41, and one of its inlet ports 112, provided to be connected to the reservoir 44, the two other inlet ports 111, 113, each connected to one of the orifices 431, 432 of the hydraulic pump 43, remaining blocked. Hence, the hydraulic motor 41 can empty at least a part of its fluid into the reservoir 44 and, where applicable, the pistons can retract, then remain in their housings, as long as the orifices 411, 412 of the hydraulic motor 41 are at the pressure of the reservoir 44. Hence, even if the hydraulic motor 41 continues to run, given its coupling to the wheel 42 by way of its cam, no resistive torque is transmitted from the hydraulic motor 41 to the wheel 42, the cam no longer being in contact with the pistons. The traction assistance is, then, disabled.

In an operational configuration, a pressure has set itself up within the control chamber 14 of the free-wheeling valve 1 and this pressure is large enough to counteract the force exerted by the returning element 15 on the slide 13 of the free-wheeling valve 1, so that the free-wheeling valve 1 passes from the idle position P5 to an active position P6, in which it allows the circulation of fluid between the hydraulic pump 43 and the hydraulic motor 41. More precisely, in the active position P6, circulation is allowed between each of the inlet ports 111, 113 connected to the orifices 431, 432 of the hydraulic pump 43 and each of the outlet ports 121, 122, the inlet port 112 provided to be connected to the reservoir 44 remaining blocked. The traction assistance is, then, enabled.

FIG. 1 illustrates that the free-wheeling valve 1 is controlled by a hydraulic control valve 2, connected to the free-wheeling valve 1.

The hydraulic control valve 2 is a hydraulically-controlled directional electric valve and has a similar structure to that of the free-wheeling valve 1, with the difference that it has only two inlet ports 211, 212, one provided to be connected to the reservoir 44, and the other to the booster line 400, and an outlet port 221 provided to be connected to the control chamber 14 of the free-wheeling valve 1, preferably by way of a line comprising a nozzle 48 provided to adjust the flow rate coming from the booster line 400, as will be described in more detail below.

In an idle position P1, or default position, in which the pressure within the control chamber 24 of the hydraulic control valve 2 is negligible by comparison with the force exerted by the return element 25 of the hydraulic control valve 2 on the slide of the hydraulic control valve 2, the slide 23 of the hydraulic control valve 2 allows the circulation of fluid between its outlet port 221 and its inlet port 211 connected to the reservoir 44, the other inlet port 212 remaining blocked. Hence, the control chamber 14 of the free-wheeling valve 1 can empty out at least a part of its fluid and the pressure being set up therein can become negligible compared to the force exerted by the return element 15 of the free-wheeling valve 1 on the slide 13 of the free-wheeling valve 1. Thus, the free-wheeling valve 1 can transition from its active position P6 to its idle position P5. Furthermore, once the free-wheeling valve 1 is in its idle position P5, the hydraulic motor 41 can empty out its fluid by way of the hydraulic control valve 2 and thus the traction assistance can be disabled. More precisely, the disabling of the hydraulic control valve 2 makes it possible to disable the free-wheeling valve 1. Hence, the hydraulic motor 41 is isolated from the hydraulic pump 43 and is then connected to the reservoir 44, by way of the free-wheeling valve 1 and the hydraulic control valve 2, which causes the retraction of the pistons of the hydraulic motor 41 and the disengagement of the wheel 42.

In an operational configuration, a pressure has set itself up within the control chamber 24 of the hydraulic control valve 2 and this pressure is high enough to counteract the force exerted by the return element 25 of the hydraulic control valve 2 on the slide 23 of the hydraulic control valve 2, so that the slide 23 of the hydraulic control valve 2 passes from the idle position P1 to an active position P2, wherein it allows the circulation of fluid between the booster line 400 and the hydraulic motor 41 as long as the free-wheeling valve 1 is still in its idle position P5, but also between the booster line 400 and the control chamber 14 of the free-wheeling valve 1. More precisely, in the active position P2, the circulation of fluid is allowed between the inlet port 212 connected to the booster line 400 and the outlet port 221, the inlet port 211 provided to be connected to the reservoir 44 remaining blocked.

This active position P2 of the hydraulic control valve 2 eventually makes it possible to set up and maintain a pressure in the control chamber 14 of the free-wheeling valve 1, so as to counteract the force exerted on the slide 15 of the free-wheeling valve 1 by the return element 15 of the free-wheeling valve 1, thus making the free-wheeling valve 1 pass from its idle position P5 to its active position P6. More precisely, the enabling of the hydraulic control valve 2 makes it possible to enable the free-wheeling valve 1.

This active position P2 of the hydraulic control valve 2 also makes it possible to time the switching from the idle position P5 to the active position P6 of the free-wheeling valve 1, using the nozzle 48, and does so to promote the engagement of the hydraulic motor 41 with the wheel 42. Specifically, by adjusting the flow rate coming from the booster line 400, the nozzle 48 makes it possible not only to take into account the properties of the control chamber 14 of the free-wheeling valve 1, but also to prioritize, at least in a first sequence of the switching, the circulation of fluid toward the inlet port 112 of the free-wheeling valve 1 via which the hydraulic motor 41 is supplied, rather than toward the control chamber 14 of the free-wheeling valve 1. This makes it possible to extend the pistons of the hydraulic motor 41, the pressure in the line connecting the inlet port 112 of the free-wheeling valve 1 to the hydraulic motor 41 remaining low as long as the pistons have not come into contact with the cam. Once the pistons are bearing on the cam, the pressure increases in the line connecting the inlet port 112 of the free-wheeling valve 1 to the hydraulic motor 41, until a level equivalent to that established in the booster line 400 is reached. Hence, the flow rate of fluid toward the hydraulic motor 41 becomes lower, and a high pressure is set up downstream of the nozzle 48, i.e. within the control chamber 14 of the free-wheeling valve 1, in such a way as to switch the slide 13 of the free-wheeling valve 1 from the idle position P5 to the active position P6. Once in the active position P2, the hydraulic motor 41 is put in communication with the hydraulic pump 43, this communication only being implemented once the pistons have been extended. Hence, sequentially, the pistons are extended first, which allows the hydraulic motor 41 to engage the wheel 42, then the free-wheeling valve 1 is switched, secondly, which makes it possible to transmit the pressure from the hydraulic pump 43 to the hydraulic motor 41.

Thus, the combination of the free-wheeling valve 1, of the nozzle 48 and of the hydraulic control valve 2 makes it possible to guarantee a high flow rate of fluid to supply the hydraulic motor 41 at the booster pressure and thus extend its pistons more quickly.

FIG. 1 illustrates that the hydraulic control valve 2 is controlled by a directional electric valve 3, connected to the hydraulic control valve 2, and more precisely to the control chamber 24 of the hydraulic control valve 2. Specifically, the behavior of the directional electric valve 3 determines the pressure being set up within the control chamber 24 of the hydraulic control valve 2 and, hence, the passing of the hydraulic control valve 2 from its idle position P1 (disabling of the free-wheeling valve 1 and, hence, of the traction assistance) to its active position P2 (enabling of the free-wheeling valve 1 and, hence, of the traction assistance).

The directional electric valve 3 has a similar structure to that of the hydraulic control valve 2, with the difference that its outlet port 321 is provided to be connected to the control chamber 24 of the hydraulic control valve 2 and that it is not a pressure being set up in a control chamber which counteracts the force exerted by the return element 35 of the electric valve on the slide 33 of the directional electric valve 3, but the action of a solenoid 34.

In an idle position P3, or default position, in which the solenoid 34 is disabled, the slide 33 of the directional electric valve 3 allows the circulation of fluid between its outlet port 321 and its inlet port 311 connected to the reservoir 44, the other inlet port 312 remaining blocked. In this way, the control chamber 24 of the hydraulic control valve 2 can empty out at least a part of its fluid and the pressure being set up in it can become negligible compared to the force exerted by the return element 25 of the hydraulic control valve 2 on the slide 23 of the hydraulic control valve 2. Thus, the hydraulic control valve 2 can transition from tis active position P2 to its idle position P1 to disable the free-wheeling valve 1 and the traction assistance. More precisely, the disabling of the directional electric valve 3 makes it possible to disable the hydraulic control valve 2 and, hence, to disable the traction assistance.

In an operational configuration, the solenoid 34 has become enabled, for example by means of a remote control implemented by the driver of the vehicle, and the force that the solenoid 34 exerts on the slide 33 of the directional electric valve 3 has become great enough to counteract the force exerted by the return element of the directional electric valve 3 on the slide 33 of the directional electric valve 3, so that the slide 33 of the directional electric valve 3 passes from the idle position P3 to an active position P4, in which it allows the circulation of fluid between the booster line 400 and the control chamber 24 of the hydraulic control valve 2. More precisely, in the active position P4, the circulation of fluid is allowed between the inlet port 312 connected to the booster line 400 and the outlet port 321, the inlet port 311 provided to be connected to the reservoir 44 remaining blocked. This active position P4 of the directional electric valve 3 makes it possible to set up and maintain a pressure in the control chamber 24 of the hydraulic control valve 2, so as to counteract the force exerted on the slide 23 of the hydraulic control valve 2 by the return element 25 of the hydraulic control valve 2, thus making the hydraulic control valve 2 transition from its idle position P1 to its active position P2. The traction assistance can, thus, be enabled. More precisely, the enabling of the directional electric valve 3 makes it possible to enable the hydraulic control valve 2 and, hence, to enable the traction assistance.

To disable the assistance, the hydraulic motor 41 must be disengaged.

To do this, the solenoid 34 is disabled, so that the directional electric valve 3 switches from its active position P4 to its idle position P3, causing the control chamber 24 of the hydraulic control valve 2 to be put at the pressure of the reservoir 44, which then switches from its active position P2 to its idle position P1. In its idle position P1, the hydraulic control valve 2 makes it possible to set up a pressure at the orifices 411, 412 of the hydraulic motor 41 which is identical to the pressure of the reservoir 44. As the wheel 42 continues to drive the hydraulic motor 41, the cam and/or the pressure within the casing of the hydraulic motor 41 push back the pistons, which retract. Until all the pistons are in the retracted position, the flow rate of fluid which is discharged from the hydraulic motor 41 toward the reservoir 44, by way of the free-wheeling valve 1 and the hydraulic control valve 2, is a flow rate of the same order as the flow rate circulating within the hydraulic motor 41 when the assistance is enabled, when the hydraulic motor 41 is connected to the hydraulic pump 43 and when the rotation speed of the wheel 42 is nominal. Once all the pistons are retracted and disengaged from the cam, the flow rate circulating from the hydraulic motor 41 toward the reservoir 44 becomes, on the other hand, zero.

Note that, in a variant, a system of return members can be provided to keep the pistons in the retracted position as default for as long as the orifices 411, 412 of the hydraulic motor 41 are not exposed to the pressure of the fluid discharged by the hydraulic pump 43.

Thus, whether it is in its idle position P1 or in its active position P2, the hydraulic control valve 2 is dimensioned to allow the circulation of fluid at a high flow rate, i.e. of the same order of magnitude as the nominal flow rate of the hydraulic motor 41, once engaged and put in communication with the hydraulic pump 43.

Hence, the flow rate of the fluid expelled from the pistons to retract them is equivalent to the flow rate to which the hydraulic motor 41 was exposed until the moment its orifices 411, 412 were suddenly put in communication with the reservoir 44, the hydraulic control valve 2 having switched from its active position P2 to its idle position P1. Hence, at this exact moment, the cam is still connected to the wheel 42 and the pistons are in contact with the cam. However, this flow rate to which the hydraulic motor 41 was exposed can prove to be the full permissible flow rate of the hydraulic motor 41 at its maximum rotation speed. Similarly, the fluid flow rate provided to retract the pistons can itself be very high, typically between 0.33 and 0.5 times the maximum flow rate acceptable by the hydraulic motor 41.

On the other hand, the flow rate for controlling the free-wheeling valve 1, i.e. the flow rate of fluid circulating from the outlet port 222 of the hydraulic control valve 2 toward the control chamber 14 of the free-wheeling valve 1 to switch the free-wheeling valve 1, is in the order of a few millimeters during a fraction of a second.

Consequently, a ratio of the flow rate for controlling the free-wheeling valve 1 to the flow rate for supplying the hydraulic motor 41 from the booster line 400 to extend the pistons (hydraulic control valve 2 in the active position P2), or the flow rate of discharge from the hydraulic motor 41 toward the reservoir 44 to retract the pistons (hydraulic control valve 2 in the idle position P1), when the free-wheeling valve 1 is in the idle position P5, is between 80 and 120, and preferably has a value of 100.

The hydraulic control valve 2 is dimensioned to allow the circulation of fluid through its slide 23 at flow rates which are just as high but without generating any significant load loss, so that the disengagement and engagement of the hydraulic motor 41 can occur quickly.

In an exemplary embodiment of the circuit, the hydraulic motor 41 is provided to consume 100 liters per minute at 45 revolutions per minute, which requires the hydraulic pump 43 to be provided to output 200 liters per minute, assuming that the secondary axle comprises two wheels 42, each coupled to a hydraulic motor 41. Moreover, the volume of fluid necessary to extend the pistons of the hydraulic motor 41 is typically of 150 cm³. In operation, the hydraulic motor 41 is provided to operate at a pressure between the booster pressure and 600 bar (i.e. 600·10⁵ Pa), typically 300 bar (i.e. 300·10⁵ Pa). Furthermore, the flow rate of fluid needed for the control of the control chamber 14 of the free-wheeling valve 1 is between 2 and 3 liters per minute, and the free-wheeling valve 1 is provided to switch from its idle position P5 to its active position P6 when a pressure of at least 12 bar (i.e. 12·10⁵ Pa) is set up within the control chamber 14 of the free-wheeling valve 1. Finally, the flow rate of fluid necessary for the control the control chamber 24 of the hydraulic control valve 2 is of 1 liters per minute, and the hydraulic control valve 2 is provided to switch from its idle position P1 to its active position P2 when a pressure of at least 7 bar (i.e. 7·10⁵ Pa) is set up within the control chamber 24 of the hydraulic control valve 2. The directional electric valve 3, meanwhile, is dimensioned to provide a limited control flow rate in the direction of the hydraulic control valve 2. Typically, the flow rate necessary for this control is in the order of 2 liters per minute, preferably 1 liter per minute, at the booster pressure. Furthermore, the directional electric valve 3 operates with an amperage of less than 2 A, typically 1.4 A, and an electrical power of less than 20 W, typically 17 W. The joint use of the directional electric valve 3 and of the hydraulic control valve 2 thus makes it possible to limit the electrical power necessary to control the circuit.

Upon engagement of the hydraulic motor 41, the flow rate of the booster pump 45 is typically of 50 liters per minute. The time taken to engage the pistons is of 0.5 seconds, i.e. a flow rate in the order of 20 liters per minute for the hydraulic motor 41, and of 40 liters per minute for a secondary axle comprising two wheels 42, each coupled to a hydraulic motor 41. Moreover, the time taken to switch the slide 13 of the free-wheeling valve 1 is of 0.2 seconds.

Upon disengagement of the hydraulic motor 41, the flow rate for emptying the cylinders of the hydraulic motor 41 is equivalent to the flow rate of operation of the hydraulic motor 41 at its rotation speed, for example 100 liters per minute. The emptying time is of 0.5 seconds at the nominal speed of the hydraulic motor 41.

This exemplary embodiment makes it possible to observe that the flow rate needed for controlling the valves 1, 2 is in the order of 1 to 2 liters per minute, while the flow rate for supplying the hydraulic motor 41 is in the order of 100 liters per minute. The hydraulic control valve 2 is therefore dimensioned to circulate a fluid flow rate of 2 liters per minute for controlling the free-wheeling valve 1, and between 50 and 100 liters per minute for supplying the hydraulic motor 41 during the expansion or retraction of the pistons. Thus, the hydraulic motor 41 is able to be engaged and disengaged very quickly, within a time period of less than 1 second. In this way, it is possible to engage or disengage the assistance of the wheel 42 even when the vehicle is in motion, and when the hydraulic motor 41 is driven by the wheel 42, and to do so while minimizing noise, torque jolts, pressure spikes, and mechanical impacts at the pistons.

Thus, using a hydraulically controlled directional valve 2 to control the free-wheeling valve 1 makes it possible to make a high flow rate of fluid pass between the hydraulic motor 41 and, respectively, the reservoir 44 or the booster line 400. Hence, the engagement and/or disengagement of the hydraulic motor 41 are simplified. Specifically, to make such a high flow rate of fluid pass using a directional electric valve, instead and in place of the hydraulically-controlled directional valve 2 illustrated on FIG. 1, it would have been necessary to over dimension the solenoid 34, which would have given rise to an excessive circuit bulk and cost. By contrast, the directional electric valve 3 illustrated on FIG. 1, insofar as it only controls the hydraulic control valve 2, and no longer directly controls the free-wheeling valve 1, can be smaller, particularly because it only needs to let a low flow rate of fluid pass, and can therefore be less bulky and less energy-hungry.

The circuit illustrated on FIG. 1 can be used solely for the traction assistance of the vehicle. In this case, the primary axle is driven by the primary motor of the vehicle, by means of a primary transmission, which may comprise a clutch, a gear box and/or a drive train. In this case, the assembly formed of the power takeoff, any clutch, and the circuit, constitutes a secondary transmission via which a torque supplied by the primary motor is able to be transmitted to the non-drive wheel 42, when the assistance is enabled. The secondary transmission is then independent of the primary transmission. In fact, the secondary axle is not driven by the primary transmission, but by the secondary transmission.

Alternatively, the circuit illustrated on FIG. 1 is also used to transmit the mechanical power from the primary motor to the drive wheels of the primary axle. Where applicable, each of the low-pressure line and the high-pressure line of the communicating circuit 40 is moreover connected, in parallel with the hydraulic motor 41, to the orifices of at least one other hydraulic motor (not shown), this connection to the other hydraulic motor being done upstream of the free-wheeling valve 1, i.e. directly at the orifices 431, 432 of the hydraulic pump 43. The other hydraulic motor is, meanwhile, coupled to the primary axle, which can be a bridge axle with a differential equipped, or not equipped, with a reduction mechanism.

Whatever the case, the direction of flow within the communicating circuit 40 is modified according to the desired direction of motion (forward or reverse) of the wheels, whether or not they are drive wheels.

1-24. (canceled)

25. An assembly comprising:
a free-wheeling valve;
a hydraulic control valve connected to the free-wheeling valve, and configured to control the free-wheeling valve; and
a directional electric valve connected to the hydraulic control valve, and configured to control the hydraulic control valve.

26. The assembly of claim 25, wherein the hydraulic control valve comprises:
a first inlet port provided to be connected to a reservoir of a hydraulic circuit for assisting a traction of a vehicle;
a second inlet port provided to be connected to a booster line of the hydraulic circuit;
an outlet port connected to a first control chamber of the free-wheeling valve, and to a third inlet port of the free-wheeling valve;
a slide and a body, the slide being movable within the body between:
a first position in which the slide allows a circulation of fluid between the first inlet port and the outlet port, and prohibits a circulation of fluid between the second inlet port and the outlet port; and
a second position in which the slide allows the circulation of fluid between the second inlet port and the outlet port, and prohibits the circulation of fluid between the first inlet port and the outlet port;
a second control chamber connected to the directional electric valve and to the slide so that a pressure within the second control chamber exerts a first force on the slide; and
a return element connected to the slide and to the body, so as to exert a second force on the slide;
wherein a movement of the slide between the first position and the second position is controlled by a difference between the first force and the second force.

27. The assembly of claim 25, wherein the directional electric valve comprises:
a first inlet port provided to be connected to a reservoir of a hydraulic circuit for assisting a traction of a vehicle;
a second inlet port provided to be connected to a booster line of the hydraulic circuit;
an outlet port connected to a control chamber of the hydraulic control valve;
a slide and a body, the slide being movable within the body between:
a first position in which the slide allows a circulation of fluid between the first inlet port and the outlet port, and prohibits a circulation of fluid between the second inlet port and the outlet port; and
a second position in which the slide allows the circulation of fluid between the second inlet port and the outlet port, and prohibits the circulation of fluid between the first inlet port and the outlet port;
a solenoid configured to exert a first force on the slide; and
a return element connected to the slide and to the body, so as to exert a second force on the slide;
wherein a movement of the slide between the first position and the second position is controlled by a difference between the first force and the second force.

28. The assembly of claim 25, wherein the free-wheeling valve comprises:
a first inlet port provided to be connected to a first orifice of a hydraulic pump of a hydraulic circuit for assisting a traction of a vehicle;
a second inlet port provided to be connected alternatively to a reservoir of the hydraulic circuit or to a booster line of the hydraulic circuit, by way of the hydraulic control valve;
a third inlet port provided to be connected to a second orifice of the hydraulic pump;
a first outlet port provided to be connected to a first orifice of a hydraulic motor of the hydraulic circuit;
a second outlet port provided to be connected to a second orifice of the hydraulic motor;
a slide and a body, the slide being movable within the body between:
a first position in which the slide allows a circulation of fluid between the second inlet port and each of the first outlet port and of the second outlet port, and prohibits a circulation of fluid between each of the first inlet port and of the third inlet port, and each of the first outlet port and of the second outlet port; and
a second position in which the slide allows a circulation of fluid between the first inlet port and the first outlet port, and between the third inlet port and the second outlet port, and prohibits a circulation of fluid between the first inlet port and the second outlet port, between the second inlet port and each of the first outlet port and of the second outlet port, and between the third inlet port and the first outlet port;
a control chamber connected to the hydraulic control valve and to the slide so that a pressure within the control chamber exerts a first force on the slide; and a return element connected to the slide and to the body, so as to exert a second force on the slide;
wherein a movement of the slide between the first position and the second position is controlled by a difference between the first force and the second force.

29. The assembly of claim 25, wherein:
the free-wheeling valve comprises:
a first inlet port provided to be connected to a first orifice of a hydraulic pump of a hydraulic circuit for assisting a traction of a vehicle;
a second inlet port provided to be connected alternatively to a reservoir of the hydraulic circuit or to a booster line of the hydraulic circuit, by way of the hydraulic control valve;
a third inlet port provided to be connected to a second orifice of the hydraulic pump;
a first outlet port provided to be connected to a first orifice of a hydraulic motor of the hydraulic circuit;
a second outlet port provided to be connected to a second orifice of the hydraulic motor;
a first slide and a first body, the first slide being movable within the first body between:
a first position in which the first slide allows a circulation of fluid between the second inlet port and each of the first outlet port and of the second outlet port, and prohibits a circulation of fluid between each of the first inlet port and of the third inlet port, and each of the first outlet port and of the second outlet port; and
a second position in which the first slide allows a circulation of fluid between the first inlet port and the first outlet port, and between the third inlet port and the second outlet port, and prohibits a circulation of fluid between the first inlet port and the second outlet port, between the second inlet port and each of the first outlet port and of the second outlet port, and between the third inlet port and the first outlet port;
a first control chamber connected to the hydraulic control valve and connected to the first slide so that a pressure within the first control chamber exerts a first force on the first slide; and
a first return element connected to the first slide and to the first body, so as to exert a second force on the first slide;
wherein a movement of the first slide between the first position and the second position is controlled by a difference between the first force and the second force; the hydraulic control valve comprises:
a third inlet port provided to be connected to the reservoir;
a fourth inlet port provided to be connected to the booster line;
a third outlet port connected to the first control chamber and to the second inlet port; and
a second slide and a second body, the second slide being movable within the second body between:
a third position in which the second slide allows a circulation of fluid between the third inlet port and the third outlet port, and prohibits a circulation of fluid between the fourth inlet port and the third outlet port; and
a fourth position in which the second slide allows the circulation of fluid between the fourth inlet port and the third outlet port, and prohibits the circulation of fluid between the third inlet port and the third outlet port; and
wherein, in the first position of the free-wheeling valve and in the fourth position of the hydraulic control valve, the free-wheeling valve and the hydraulic control valve are configured to connect the booster line to the first control chamber and to the motor.

30. The assembly of claim 25, herein:
the free-wheeling valve comprises:
a first inlet port provided to be connected to a first orifice of a hydraulic pump of a hydraulic circuit for assisting a traction of a vehicle;
a second inlet port provided to be connected alternatively to a reservoir of the hydraulic circuit or to a booster line of the hydraulic circuit, by way of the hydraulic control valve;
a third inlet port provided to be connected to a second orifice of the hydraulic pump;
a first outlet port provided to be connected to a first orifice of a hydraulic motor of the hydraulic circuit;
a second outlet port provided to be connected to a second orifice of the hydraulic motor;
a first slide and a first body, the first slide being movable within the first body between:
a first position in which the first slide allows a circulation of fluid between the second inlet port and each of the first outlet port and of the second outlet port, and prohibits a circulation of fluid between each of the first inlet port and of the third inlet port, and each of the first outlet port and of the second outlet port; and
a second position in which the first slide allows a circulation of fluid between the first inlet port and the first outlet port, and between the third inlet port and the second outlet port, and prohibits a circulation of fluid between the first inlet port and the second outlet port, between the second inlet port and each of the first outlet port and of the second outlet port, and between the third inlet port and the first outlet port;
a control chamber connected to the hydraulic control valve and connected to the first slide so that a pressure within the control chamber exerts a first force on the first slide; and
a first return element connected to the first slide and to the first body, so as to exert a second force on the first slide;
wherein a movement of the first slide between the first position and the second position is controlled by a difference between the first force and the second force;
the hydraulic control valve comprises:
a third inlet port provided to be connected to the reservoir;
a fourth inlet port provided to be connected to the booster line; and
a third outlet port connected to the control chamber and to the second inlet port; and
wherein the assembly further comprises a line connecting the third outlet port to the control chamber, the line comprising a nozzle provided to adjust a flow rate coming from the booster line.

31. A hydraulic circuit for assisting a traction of a vehicle, the hydraulic circuit comprising:
a hydraulic motor provided to be coupled to a wheel of the vehicle;
a hydraulic pump; and
the assembly of claim 25;
wherein the free-wheeling valve of the assembly is configured to control a circulation of fluid between the hydraulic pump and the hydraulic motor.

32. The hydraulic circuit of claim 31, wherein the hydraulic pump comprises a first orifice and a second orifice, and the hydraulic motor comprises a third orifice and a fourth orifice, the hydraulic circuit further comprising:
a communicating circuit connecting the first orifice to the third orifice, and the second orifice to the fourth orifice, the communicating circuit comprising the free-wheeling valve of the assembly;
a reservoir;
a booster pump comprising an intake orifice connected to the reservoir and a discharge orifice; and
a booster line connected to the discharge orifice and to the communicating circuit; wherein the free-wheeling valve and the hydraulic control valve of the assembly are configured to control a circulation of fluid between, on the one hand, the hydraulic motor and, on the other hand, the hydraulic pump, the booster line and/or the reservoir.

33. The hydraulic circuit of claim 32, wherein the hydraulic control valve of the assembly is configured to allow the circulation of fluid between the hydraulic motor and the booster line and/or the reservoir at a flow rate between 50 and 100 liters per minute.

34. The hydraulic circuit of claim 31, wherein an engagement time and/or a disengagement time of the hydraulic motor is less than 1 second.

35. The hydraulic circuit of claim 31, wherein the directional electric valve of the assembly is configured to consume an electrical power of less than 20 W for a control of the hydraulic control valve.

36. A vehicle comprising:
a primary axle provided to support at least one drive wheel of the vehicle;
a secondary axle, separate from the primary axle;
a wheel mounted on the secondary axle; and
the hydraulic circuit of claim 31, wherein the hydraulic motor of the hydraulic circuit is coupled to the wheel.

37. A method comprising:
controlling a hydraulic control valve with a directional electric valve; and
controlling a free-wheeling valve of a hydraulic motor of a vehicle with the hydraulic control valve, the hydraulic motor being coupled to a wheel of the vehicle mounted of an axel of the vehicle, the axle being separate from a drive axle of the vehicle provided to support at least one drive wheel of the vehicle;
wherein an enabling of the directional electric valve causes an enabling of the hydraulic control valve so as to enable the free-wheeling valve to set up a circulation of fluid first between the hydraulic motor and a booster line of the vehicle, then between a hydraulic pump of the vehicle and the hydraulic motor; and
wherein a disabling of the directional electric valve causes a disabling of the hydraulic control valve so as to disable the free-wheeling valve to isolate the hydraulic pump from the hydraulic motor and connect the hydraulic motor to a reservoir of the vehicle, by way of the hydraulic control valve.
